(19) United States
(12) Patent Application Publication
(10) Pub. No.: US 2016/0312510 A1
(43) Pub. Date: Oct. 27, 2016

(54) SAFETY DEVICE FOR SPRING-LOADED MECHANISM

(71) Applicant: Strattec Power Access LLC, Auburn Hills, MI (US)

(72) Inventors: Jeffrey S. Hamminga, Troy, MI (US); Phillip Metz, Warren, MI (US); Howard W. Kuhlman, Rochester Hills, MI (US); David P. Wilcox, Kingston, MI (US); Mark Adams, Troy, MI (US); Eric R. Hansen, Lake Orion, MI (US)

(21) Appl. No.: 15/079,271

(22) Filed: Mar. 24, 2016

Related U.S. Application Data
(60) Provisional application No. 62/138,805, filed on Mar. 26, 2015.
(60) Provisional application No. 62/142,233, filed on Apr. 2, 2015.

(51) Int. Cl. E05F 1/10; F03G 1/10; F03G 1/02

(52) U.S. Cl. CPC E05F 1/105; F03G 1/02; F03G 1/10; E05Y 2201/422; E05Y 2900/546

(57) ABSTRACT

The present invention provides a drive mechanism for a vehicle lift gate. The drive mechanism includes a housing including a first end securable to a vehicle frame and an opposite second end securable to a lift gate. The drive mechanism further includes a spring disposed for movement within the housing along the axis between the first and second ends and biasing the first end axially relative to the second end. A damper extends around the housing for absorbing energy released by rapid axial movement of the spring relative to the housing.

### FIELD OF THE INVENTION

This application claims the benefit of U.S. Provisional Application No. 62/138,805, filed Mar. 26, 2015 and U.S. Provisional Application No. 62/142,233, filed Apr. 2, 2015.

The present invention relates to spring-loaded mechanisms, particularly spring-loaded mechanisms used in vehicles.

### BACKGROUND OF THE INVENTION

Spring-loaded mechanisms, such as spring-loaded actuators and spring-loaded dampers used in vehicles, often have assembly defects or become damaged during use. If a spring-loaded mechanism is damaged severely enough, the spring on the spring-loaded mechanism may extend freely or with only minor resistance, allowing the spring to quickly extend in one or more directions and cause unintended damage (e.g., to the vehicle or to people nearby).

### SUMMARY OF THE INVENTION

According to one construction, the present invention provides a spring-loaded mechanism that includes an outer body, a spring disposed inside the body, the spring extending along an axis, and a safety mechanism disposed either inside or outside of the body that inhibits movement of the spring.

Other features and aspects of the invention will become apparent by consideration of the following detailed description and accompanying drawings.

### BRIEF DESCRIPTION OF THE DRAWINGS

FIG. 1 is a side view of a spring-loaded mechanism according to one construction.

FIG. 2 is a partially transparent side view of the spring-loaded mechanism of FIG. 1, illustrating an interior spring and a safety mechanism disposed radially outwardly of the spring.

FIG. 3 is a perspective view of the spring-loaded mechanism of FIG. 1.

FIG. 4 is a side, cross-sectional view of a spring-loaded mechanism according to another construction, including a safety device disposed radially inwardly of a spring.

FIG. 5 is a perspective, cross-sectional view of the spring-loaded mechanism of FIG. 4.

FIGS. 6 and 7 are perspective views of the spring-loaded mechanism according to FIGS. 4 and 5, both with and without a safety device disposed radially outwardly of the spring.

FIGS. 8 and 9 are perspective views of the spring-loaded mechanism according to FIGS. 4-7, both with and without another construction of a safety device disposed radially outwardly of the spring.

FIGS. 10 and 11 are side and cross-sectional views of the spring-loaded mechanism according to claims 1-3, illustrating use of the safety mechanism of FIGS. 8 and 9.

FIGS. 12-14 are cross-sectional views of the spring-loaded mechanism according to FIGS. 4 and 5, with another construction of a safety device disposed radially inwardly of the spring.

FIG. 15 is a cross-sectional view of the spring-loaded mechanism according to FIGS. 4 and 5, with the safety device from FIGS. 12-14.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

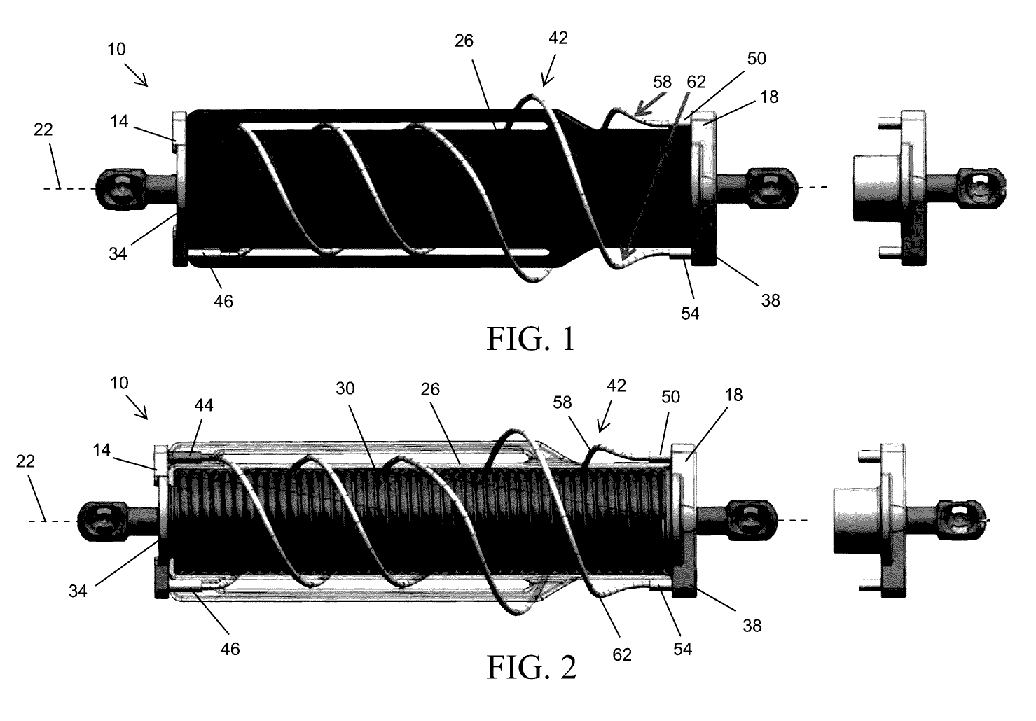

FIGS. 1-3 illustrate a spring-loaded mechanism 10. The spring-loaded mechanism 10 is a spring-loaded actuator or spring-loaded damper for use in a vehicle (e.g., a spring assist assembly for a power liftgate), although other constructions include different types of spring-loaded mechanisms for vehicle or non-vehicle use.

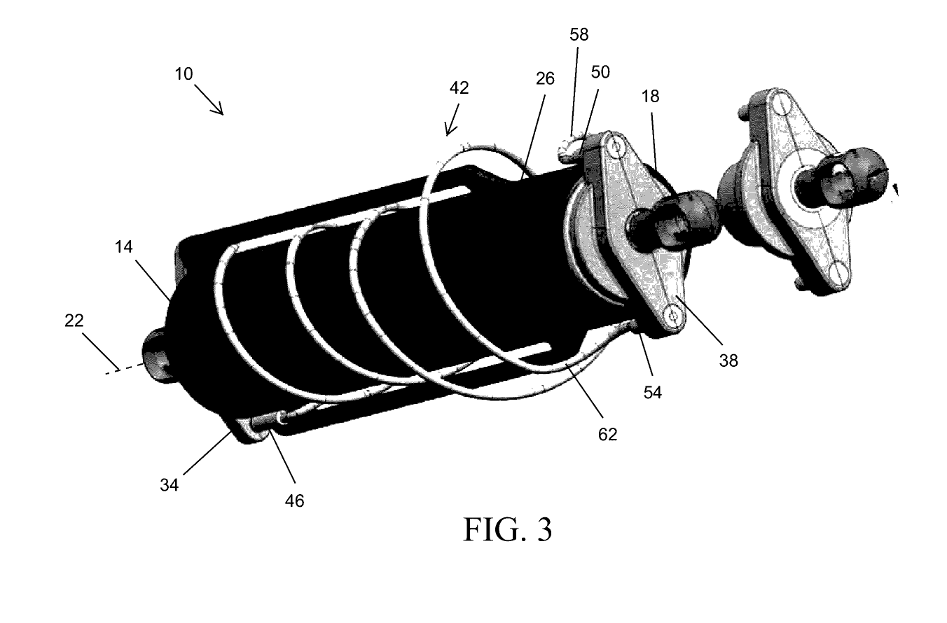

The spring-loaded mechanism 10 includes a first end 14, a second, opposite end 18, and an axis 22 extending between the first and second ends 14, 18. The spring-loaded mechanism 10 is generally cylindrical, although other constructions include different shapes. The spring-loaded mechanism 10 includes an outer body 26 and a spring 30 (FIG. 2) disposed within the outer body 26. In the illustrated construction the spring 30 is a wound spring (e.g., compression or tension spring) that is wound about the axis 22 and extends between the first end 14 and the second end 18. The spring 30 provide an actuating and/or dampening force within the spring-loaded mechanism 30, causing the first end 14 to move or be biased axially relative to the second end 18.

With continued reference to FIGS. 1-3, the spring-loaded mechanism 10 includes a first end cap 34 disposed at the first end 14 and a second end cap 38 disposed at the second end 18. In some constructions at least one of the end caps 34, 38 is removably coupled to the outer body 26.

The spring-loaded mechanism 10 further includes a safety mechanism 42 that absorbs at least a portion of the energy of the spring 30 in the event that a portion or all of the spring 30 rapidly moves (e.g., radially outwardly from axis 22, radially inwardly toward the axis 22, or axially out or in along the axis 22) and/or breaks through the outer body 26. Such movement can be due for example to the spring 130 breaking or having improper manufacturer specifications, or to other events. In the illustrated construction the safety mechanism 42 includes a first connection structure 44 (FIG. 2) and a second connection structure 46 both disposed on the first end cap 34, and a third connection structure 50 and a fourth connection structure 54 both disposed on the second end cap 38. The connection structures 44, 46, 50, 54 are projections that extend axially inwardly from the first and second end caps 34, 38.

The safety mechanism 42 further includes a first cable 58 coupled to both the first connection structure 44 and the third connection structure 50, and a second cable 62 coupled to both the second connection structure 46 and the fourth connection structure 54. In some constructions the cables 58, 62 are releasably coupled to the connection structures 44, 46, 50, and 54, such that they may be removed or replaced as desired. In some constructions ends of each of the cables 58, 62 are coupled to the connection structures 44, 46, 50, 54 via frictional fit, welding, adhesion, fasteners, or are formed integrally as one piece with the connection structures 44, 46, 50, 54. In the illustrated construction each of the cables 58, 62 is made of a fiber (e.g., woven) material that has a stretch capability that will allow it to absorb the impact energy of the spring 30.

With continued reference to FIGS. 1-3, in the illustrated construction the first and second cables 58, 62 wrap helically about the outer body 22 and the axis 22 and act as tethers to prevent or inhibit the moving (e.g., expanding) spring 30, outer body 22, or any other structure from damaging nearby components or people. In other constructions only a single, helically wound cable is used, or more than two helically wound cables are used. In some constructions at least a portion of each of the cables 58, 62 is elastic, such that when a portion of the spring 30 moves (e.g., radially outwardly or along the axis 22) the cables 58, 62 flex to a limited extent, or within a limited range, to slow down and absorb the energy of the rapidly moving spring 30.

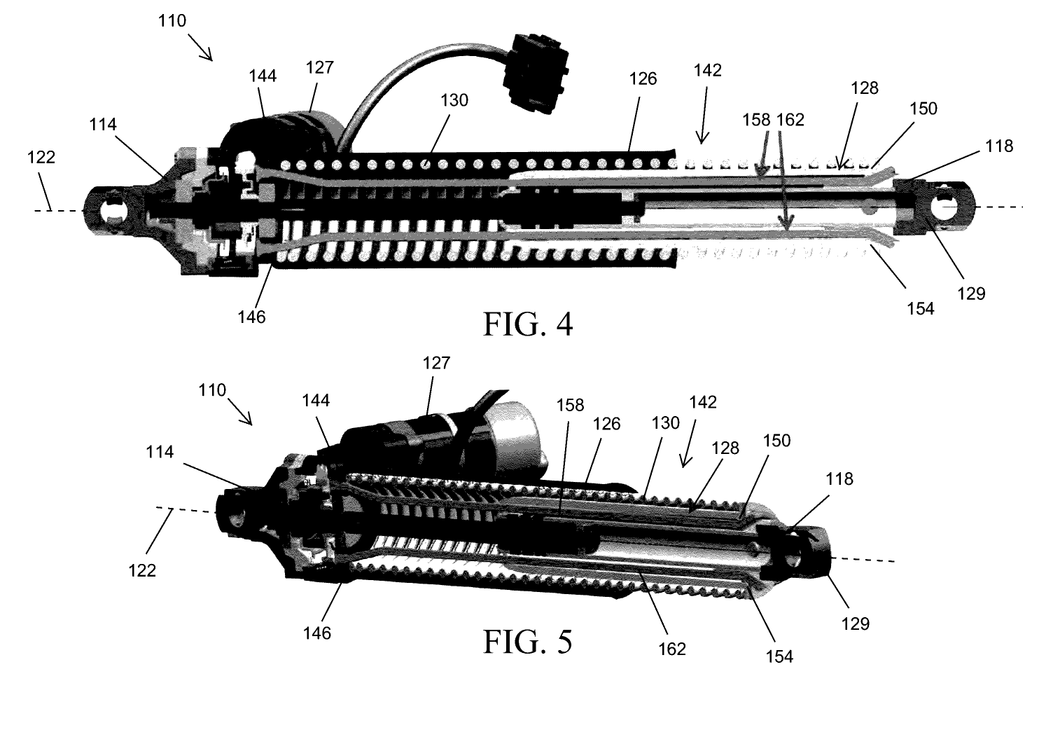

FIGS. 4 and 5 illustrate another spring-loaded mechanism 110. The spring-loaded mechanism 110 is a spring-loaded actuator or spring-loaded damper for use in a vehicle (e.g., in a motor assembly for a power liftgate), although other constructions include different types of spring-loaded mechanisms.

The spring-loaded mechanism 110 includes a first end 114, a second, opposite end 118, and an axis 122 extending between the first and second ends 114, 118. The spring-loaded mechanism 110 is generally cylindrical, although other constructions include different shapes. The spring-loaded mechanism 110 includes an outer body 126 (coupled to a motor 127 in the illustrated construction), an inner body 128 with an end fitting 129, and a spring 130 disposed at least partially within the outer body 126 and over at least a portion of the inner body 128. In the illustrated construction the spring 30 is a wound spring (e.g., compression or tension spring) that is wound about the axis 122 and extends between the first end 114 and the second end 118. The spring 130 provide an actuating and/or dampening force within the spring-loaded mechanism 110 (e.g., to cause the inner body 128 to move and/or be biased axially toward a position relative to the outer body 126).

With continued reference to FIGS. 4 and 5, the spring-loaded mechanism 110 includes a safety mechanism 142 that absorbs at least a portion of the energy of the spring 130 in the event that a portion or all of the spring 130 rapidly moves (e.g., radially inwardly toward the axis 122, radially outwardly away from the axis, or in or out along the axis 122). In some constructions movement occurs due to the spring-loaded mechanism 110 being crushed or compacted (e.g., in the event of a power liftgate failure, vehicle crash, or other event). In the illustrated construction the safety mechanism 142 includes a first connection structure 144 and a second connection structure 146 both disposed on the outer body 126, and a third connection structure 150 and a fourth connection structure 154 both disposed on the inner body 128.

The safety mechanism 142 further includes a first cable 158 coupled to both the first connection structure 144 and the third connection structure 150, and a second cable 162 coupled to both the second connection structure 146 and the fourth connection structure 154. In the illustrated construction each of the cables 158, 162 is made of a fiber (e.g., woven) material that has a stretch capability that will allow it to absorb the impact energy of the spring 130.

In some constructions the cables 158, 162 are releasably coupled to the connection structures 144, 146, 150, and 154, such that they may be removed or replaced as desired. In the illustrated construction the connection structures 144, 146, 150, 154 include walls of the outer and inner bodies 126, 128 that help to form openings or passages to receive and secure ends of the cables 158, 162. In some constructions ends of each of the cables 158, 162 are coupled to the connection structures 144, 146, 150, 154 via frictional fit, welding, adhesion, fasteners, or are formed integrally as one piece with the connection structures 144, 146, 150, 154.

With continued reference to FIGS. 4 and 5, in the illustrated construction the first and second cables 158, 162 extend generally linearly along a direction parallel to the axis 122 and act as tethers (e.g., in some constructions helping to prevent or inhibit the spring 130 from damaging nearby components or people and from damaging interior components of the spring-loaded mechanism 110). In other constructions only a single cable is used, or more than two cables are used. In some constructions at least a portion of each of the cables 158, 162 is elastic, such that when a portion of the spring 130 rapidly moves due to component failure the cables 158, 162 flex to a limited extent, or within a limited range, to slow down and absorb the energy of the moving spring 130.

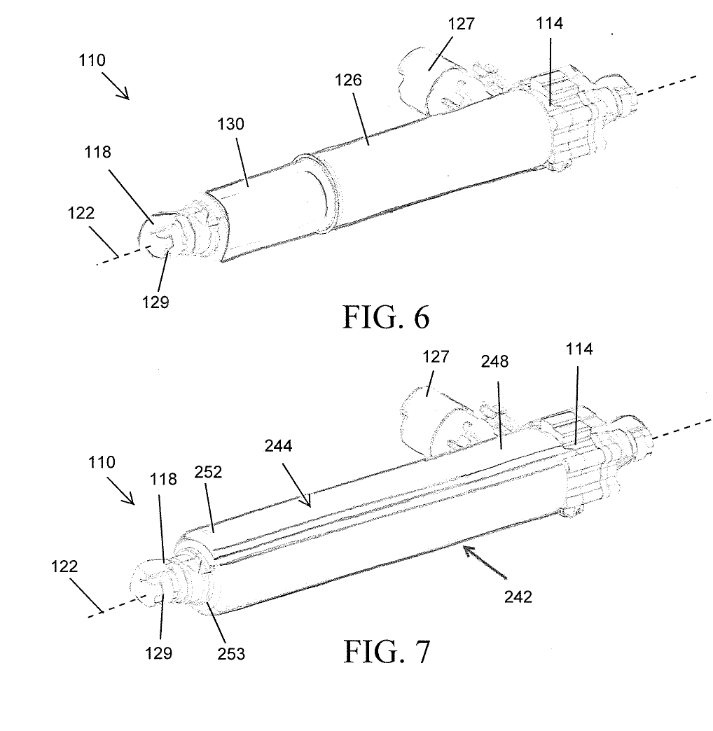

FIGS. 6 and 7 illustrate the same spring-loaded mechanism 110 from FIGS. 4 and 5, with the exception that the spring-loaded mechanism 110 includes a safety mechanism 242 (FIG. 7) that absorbs at least a portion of the energy of the spring 130 in the event that a portion or all of the spring 130 rapidly moves (e.g., radially outwardly away from the axis 122, radially inwardly toward the axis 22, or out or in along the axis 22). In the illustrated construction the safety mechanism 242 includes a sock 244 that fits over the outer body 126 as well as at least a portion of the spring 130, and extends between the first and second ends, 114, 118. In the illustrated construction the sock 244 is made of multiple layers of fiber (e.g., woven) material that each have stretch capabilities that allow them to absorb the impact energy of the spring 130. The multiple layers provide redundant protection in case one layer tears. In some constructions the spring-loaded mechanism 110 includes only the safety mechanism 242, and not the safety mechanism 142 illustrated in FIGS. 4 and 5.

With continued reference to FIGS. 6 and 7, in some constructions at least a portion of the sock 244 is elastic, such that if a portion of the spring 30 expands or otherwise moves radially outwardly the sock 244 flexes radially outwardly to a limited extent, or within a limited range, to slow down and absorb the energy of the expanding spring 130. In the illustrated construction the sock 244 includes a first end 248 and a second, opposite end 252. At least one of the first and second ends 248, 252 is sewn in (e.g., extends radially inwardly relative to the rest of the sock 244) to help further contain the spring 130 and prevent or inhibit the spring from expanding outwardly (either radially or axially). For example, in the illustrated construction the second end 252 is sewn in to provide an opening 253 through which the end fitting 129 protrudes.

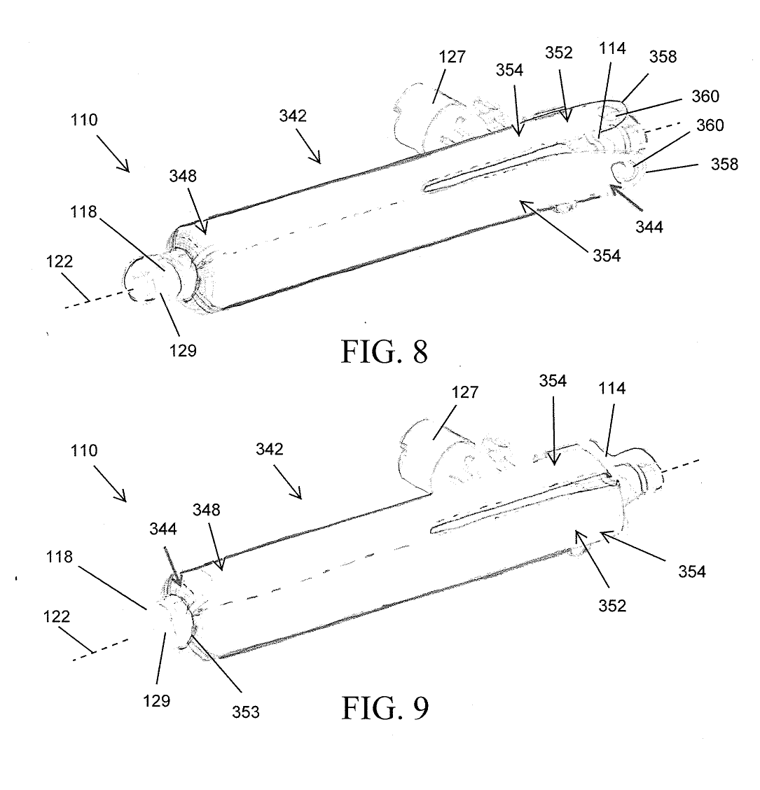

FIGS. 8 and 9 again illustrate the same spring-loaded mechanism 110 from FIGS. 4-7, with the exception that the spring-loaded mechanism 110 includes an alternative safety mechanism 342 that absorbs at least a portion of the energy of the spring 130 in the event that a portion or all of the spring 130 rapidly moves (e.g., radially outwardly away from the axis 122 or along the axis 122). In the illustrated construction the safety mechanism 342 includes a sock 344, similar to the sock 244, that fits over the outer body 126 as well as at least a portion of the spring 130, and extends between the first and second ends, 114, 118. In the illustrated construction the sock 344 is made of multiple layers of fiber (e.g., woven) material that have stretch capabilities that will allow them to absorb the impact energy of the spring 130. The multiple layers provide redundant protection in case one layer tears. In some constructions the spring-loaded mechanism 110 includes only the safety mechanism 342, and not the safety mechanism 142 illustrated in FIGS. 4 and 5. In some constructions both safety mechanisms 142, 342 are used.

With continued reference to FIGS. 8 and 9, in some constructions at least a portion of the sock 344 is elastic, such that when a portion of the spring 30 expands or otherwise moves radially outwardly the sock 344 flexes radially outwardly to a limited extent, or within a limited range, to slow down and absorb the energy of the expanding spring 30. In the illustrated construction the sock 344 includes a first end 348 that is sewn in (e.g., extends radially inwardly relative to an adjacent portion of the sock 344) to help further contain the spring 130 and prevent or inhibit the spring from expanding outwardly (either radially or axially) to damage other components or people. In the illustrated construction the first end 348 is sewn in to provide an opening 353 through which the end fitting 129 protrudes. The sock 344 further includes a second, opposite end 352 that includes multiple flaps 354 (e.g., four flaps) that may be opened and closed. As illustrated in FIG. 8, the flaps 354 include ends 358 that function as hooks that are bent radially inwardly to help secure the sock 344 to the outer body 126. In particular, the flaps 354 include openings 360 that hook over or secure to a part of the outer body 126 (e.g., to a single component, or to multiple components).

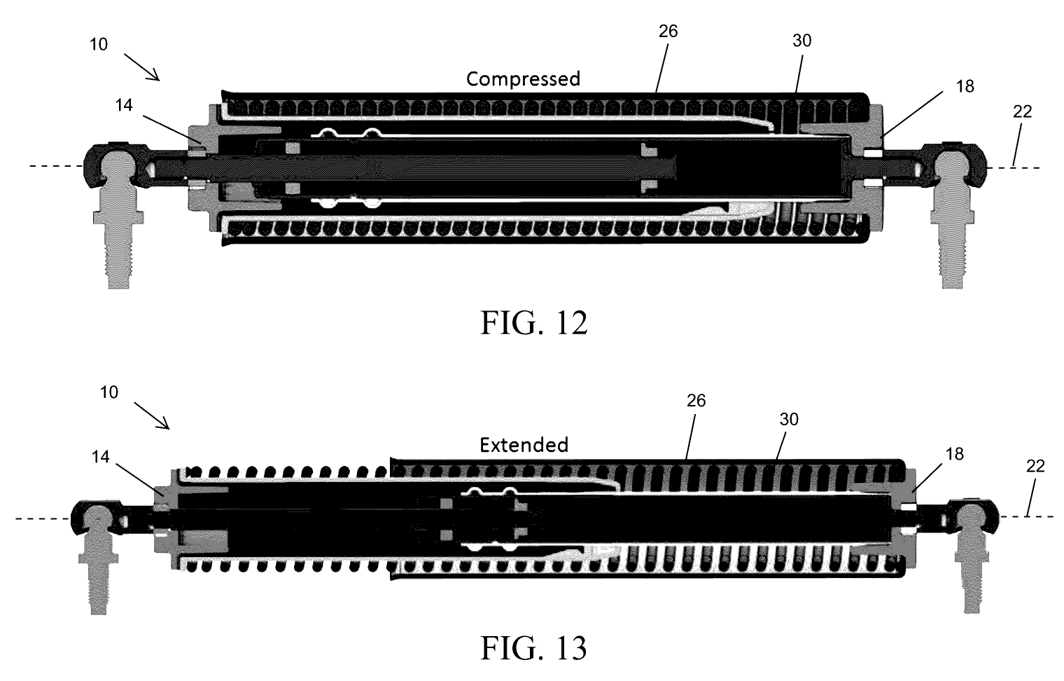

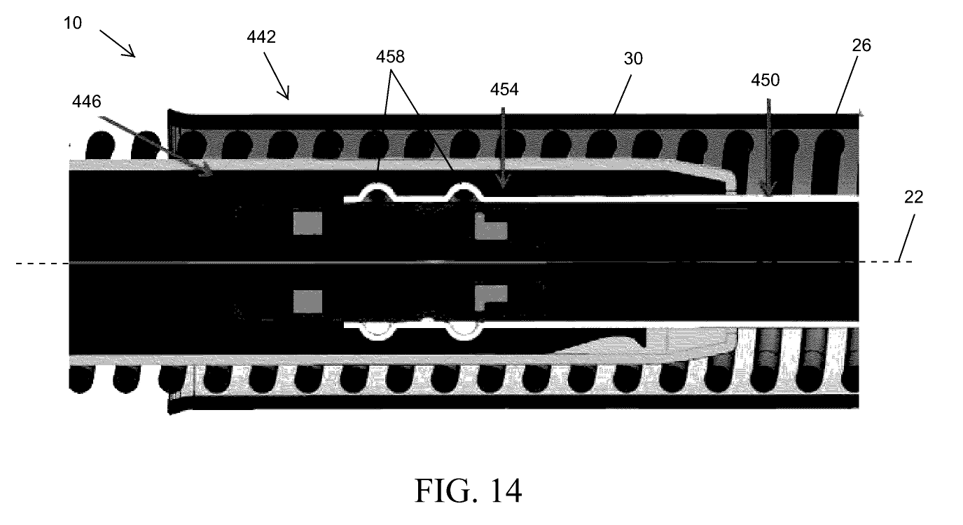

FIGS. 12-14 illustrate the same spring-loaded mechanism 10 from FIGS. 1-3, with the exception that the spring-loaded mechanism 10 includes a different safety mechanism 442 (FIG. 14) that absorbs at least a portion of the energy of the spring 30 in the event that a portion or all of the spring 30 rapidly moves (e.g., radially inwardly toward the axis 22, radially outwardly away from the axis, or out or in along the axis 22). In the illustrated construction the safety mechanism 442 includes an outer safety tube 446 (e.g., metal), an inner safety tube 450 (e.g., metal) disposed radially inwardly of the outer safety tube 446, and a compliant bushing 454 disposed radially between the outer safety tube 446 and the inner safety tube 450. The inner safety tube 450 includes a set of radially protruding ribs 458.

In the event of component failure (e.g., when the spring-loaded mechanism 10 is crushed or when a component breaks), the spring-loaded mechanism 10 may extend (see FIG. 13, as compared to FIG. 12) rapidly. If this occurs, the compliant bushing 454 will be deformed with a wedging action between the outer safety tube 446 and the inner safety tube 450, absorbing some of the energy along an axial direction (e.g., in some constructions due at least partly to its shape, as seen for example in FIG. 14 with the rectangular cross-sectional shape of the bushing 454 as compared with the angled end of the outer tube 446 adjacent the bushing 454). In some constructions the outer safety tube 446 and inner safety tube 450 themselves deform to absorb energy. In some constructions, for example in a side crush condition, the outer safety tube 446 will deflect and not allow the extension shown in FIG. 13 due to a dent or deformation on the outer safety tube 446 running into or being blocked (axially) by the ribs 458 on the inner safety tube 450. In some constructions, under a severe side crush the outer safety tube 446 and the inner safety tube 450 bend together and lock up the spring-loaded mechanism 10, preventing the spring-loaded mechanism 10 from extending as shown in FIG. 13. Overall, the safety mechanism 442 (similar to the other safety mechanisms 42, 142, 242, and 342) helps to absorb energy and decelerate the speed and energy of the spring 30.

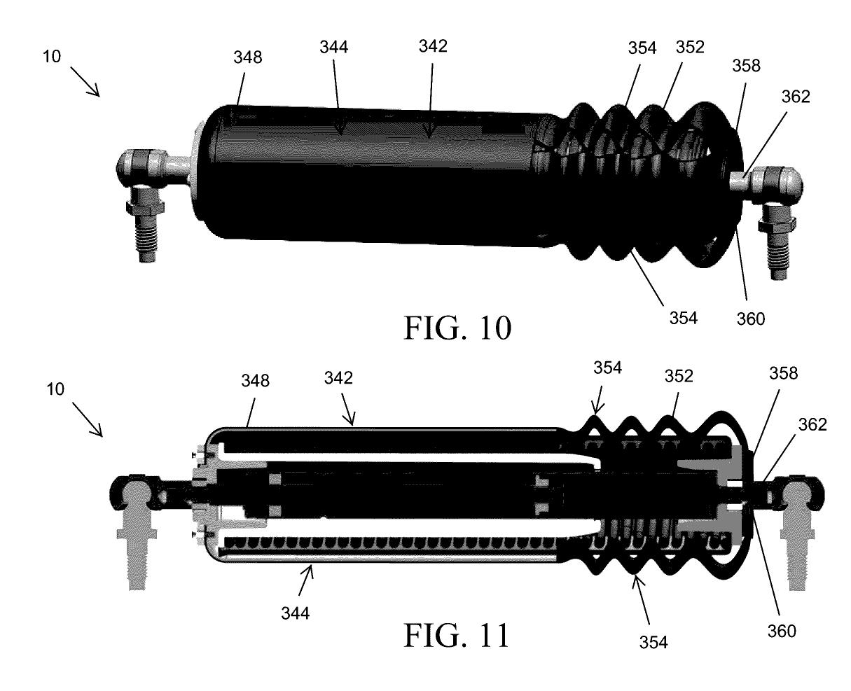

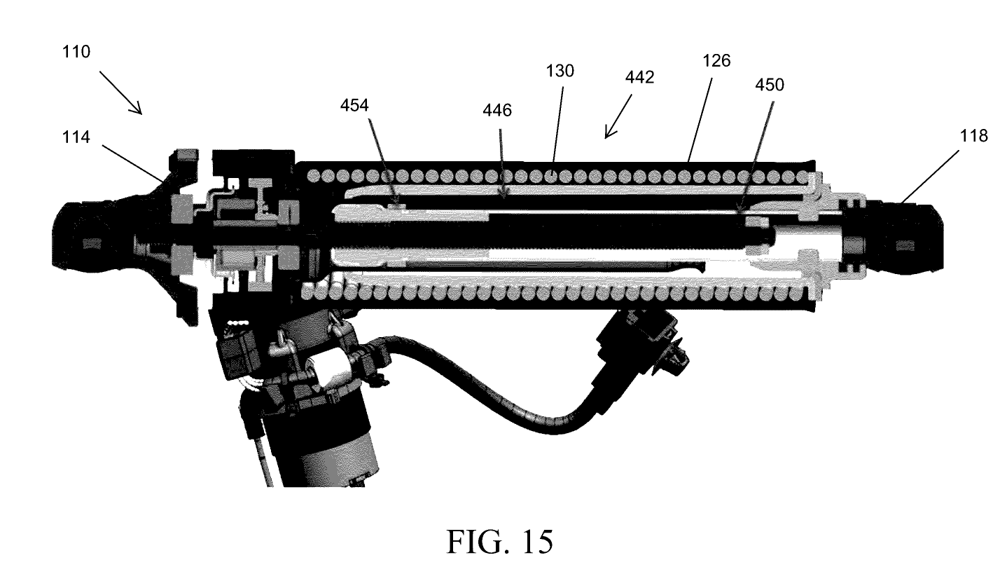

While the safety mechanisms 42, 142, 242, 342, 442 are illustrated and described above specifically with respect to particular spring loaded mechanisms 10 and 110, it is understood that each of the spring loaded mechanisms 10 and 110 (or other spring loaded mechanisms) can include one or more of each of the safety mechanisms 42, 142, 242, 342, 442 described above. For example, FIGS. 10 and 11 illustrate the spring-loaded mechanism 10 of FIGS. 1-3, but with the safety mechanism 342 disposed thereon, including the flaps 354 which in this illustrated construction all extend over a single end piece 362. Similarly, FIG. 15 illustrates the safety mechanism 442 being used on the spring-loaded mechanism 110.

Although the invention has been described in detail with reference to certain preferred embodiments, variations and modifications exist within the scope and spirit of one or more independent aspects of the invention as described.

What is claimed is:

1. A drive mechanism for use in a vehicle having a lift gate and a vehicle frame, the drive mechanism comprising:
a housing including a first end securable to the vehicle frame and an opposite second end securable to the lift gate and defining an axis extending between the first and second ends,
a spring disposed for movement within the housing along the axis between the first and second ends, the spring biasing the first end axially relative to the second end; and
a damper extending around the housing for absorbing energy released by rapid axial movement of the spring relative to the housing.
